(19) United States
(12) Patent Application Publication
(10) Pub. No.: US 2025/0162123 A1
(43) Pub. Date: May 22, 2025

(54) REACTION ARM POWER TOOL WITH CLUTCH MECHANISM

(71) Applicant: MILWAUKEE ELECTRIC TOOL CORPORATION, Brookfield, WI (US)

(72) Inventor: Mitchell A. Gibson, New Berlin, WI (US)

(21) Appl. No.: 18/951,208

(22) Filed: Nov. 18, 2024

Related U.S. Application Data
(60) Provisional application No. 63/600,508, filed on Nov. 17, 2023.

(51) Int. Cl. B25F 5/00; B25B 23/00; B25B 23/14; B25B 23/147; B25F 5/02

(52) U.S. Cl. CPC B25F 5/001; B25B 23/0078; B25B 23/141; B25B 23/147; B25F 5/026

(57) ABSTRACT

A power tool includes a housing, a motor supported within the housing, a drive assembly disposed within the housing and configured to be driven by the motor, the drive assembly including an output shaft and clutch mechanism with a collar surrounding the output shaft, the drive assembly operable in a first configuration, in which the collar is coupled for co-rotation with the output shaft, and a second configuration, in which the collar is rotatable relative to the output shaft. The power tool further includes a reaction arm configured to be removably coupled to the collar.

### CROSS-REFERENCE TO RELATED APPLICATIONS

This application claims priority to U.S. Provisional Patent Application No. 63/600,508, filed Nov. 17, 2023, the entire contents of which are incorporated herein by reference.

### FIELD

The present disclosure relates to power tools, and more specifically to shifting mechanisms for power tools.

### BACKGROUND

Reaction arm tools are a form of rotary power tool used to drive fasteners, such as nuts and bolts, particularly in high torque applications. Reaction arm tools include a reaction arm fixed to a housing of the tool and engageable with a fixed structure (e.g., an adjacent fastener in a bolt pattern). When applying torque to a fastener, the reaction arm transmits the reaction torque to the fixed structure rather than to a user holding the tool.

### SUMMARY

In some aspects, the techniques described herein relate to a power tool including: a housing; a motor supported within the housing; a drive assembly disposed within the housing and configured to be driven by the motor, the drive assembly including an output shaft and clutch mechanism with a collar surrounding the output shaft, the drive assembly operable in a first configuration, in which the collar is coupled for co-rotation with the output shaft, and a second configuration, in which the collar is rotatable relative to the output shaft; and a reaction arm configured to be removably coupled to the collar.

In some aspects, the techniques described herein relate to a power tool, wherein the drive assembly is operable in the first configuration only when the reaction arm is decoupled from the collar.

In some aspects, the techniques described herein relate to a power tool, wherein the clutch mechanism includes a spring and a detent supported by the output shaft, the spring biasing the detent toward the collar.

In some aspects, the techniques described herein relate to a power tool, further including a pin extending through the collar, wherein the pin engages the detent to displace the detent away from the collar against the bias of the spring when the reaction arm is coupled to the collar.

In some aspects, the techniques described herein relate to a power tool, wherein the reaction arm includes a protrusion engageable with the pin to displace the pin and the detent against the bias of the spring.

In some aspects, the techniques described herein relate to a power tool, wherein the detent engages the collar to couple the collar for co-rotation with the output shaft in the first configuration up to a threshold torque on the output shaft.

In some aspects, the techniques described herein relate to a power tool, wherein the detent is movable away from the collar against the bias of the spring to allow the collar to rotate relative to the output shaft in response to a torque on the output shaft exceeding the threshold torque.

In some aspects, the techniques described herein relate to a power tool, wherein the drive assembly includes a ring gear and a plurality of planet gears meshed with the ring gear, the plurality of planet gears carried by the output shaft.

In some aspects, the techniques described herein relate to a power tool, wherein the collar is fixed to the ring gear.

In some aspects, the techniques described herein relate to a power tool, wherein the collar and the reaction arm include cooperating splines.

In some aspects, the techniques described herein relate to a power tool, wherein the drive assembly includes a multi-stage planetary transmission having a plurality of gear stages, wherein each of the plurality of gear stages provides a speed reduction and torque increase when the drive assembly is in the second configuration and the reaction arm is coupled to the collar and engaged with a fixed support, and wherein at least one of the plurality of gear stages is disabled, such that the output shaft is rotatable at a relatively higher speed and lower torque, when the drive assembly is in the first configuration.

In some aspects, the techniques described herein relate to a power tool including: a housing; a motor supported within the housing; a drive assembly disposed within the housing, the drive assembly including a sun gear driven by the motor, a ring gear, a plurality of planet gears meshed with the sun gear and the ring gear, an output shaft carrying the plurality of planet gears, and a collar surrounding the output shaft; and a reaction arm configured to be removably coupled to the collar, wherein the collar is fixed to the ring gear, wherein the output shaft is rotatable relative to the ring gear when the reaction arm is coupled to the collar and engaged with a fixed support, and wherein the ring gear and the output shaft are configured to co-rotate when the reaction arm is decoupled from the collar and a torque on the output shaft is less than a threshold torque.

In some aspects, the techniques described herein relate to a power tool, wherein the ring gear is rotatable relative to the output shaft when the reaction arm is decoupled from the collar and a torque on the output shaft is greater than the threshold torque.

In some aspects, the techniques described herein relate to a power tool, wherein the drive assembly includes a clutch mechanism including the collar, a detent, and a spring, wherein the detent and the spring are supported by the output shaft, and wherein the detent is biased into engagement with the collar by the spring when the reaction arm is decoupled from the collar.

In some aspects, the techniques described herein relate to a power tool, wherein coupling the reaction arm to the collar moves the detent away from the collar against the bias of the spring.

In some aspects, the techniques described herein relate to a power tool, further including a pin extending through the collar, wherein the reaction arm includes a protrusion engageable with the pin to move the detent away from the collar.

In some aspects, the techniques described herein relate to a power tool, wherein the drive assembly includes a multi-stage planetary transmission including a plurality of gear stages, and wherein the ring gear and the plurality of planet gears define a last stage of the plurality of gear stages.

In some aspects, the techniques described herein relate to a power tool including: a housing; a motor supported within the housing; a drive assembly disposed within the housing and configured to be driven by the motor, the drive assembly including an output shaft and a collar surrounding the output shaft; and a reaction arm configured to be removably coupled to the collar, wherein the drive assembly is operable in a high speed low torque mode in response to the reaction arm being decoupled from the collar, and wherein the drive assembly is operable in a low speed high torque mode in response to the reaction arm being coupled to the collar.

In some aspects, the techniques described herein relate to a power tool, wherein the drive assembly includes a ring gear fixed to the collar and a plurality of planet gears meshed with the ring gear and carried by the output shaft.

In some aspects, the techniques described herein relate to a power tool, wherein the ring gear is rotatable relative to the housing in the high speed low torque mode.

Various other features and aspects of the present disclosure will become apparent upon considering the following description and accompanying drawings.

### BRIEF DESCRIPTION OF THE DRAWINGS

FIG. 1 is a perspective view of a power tool with a reaction arm according to an embodiment of the disclosure.

FIG. 2 is a cross-sectional view of the power tool of FIG. 1 taken along line 2-2.

FIG. 3A is an enlarged cross-sectional view of the power tool of FIG. 2 with the reaction arm coupled to the power tool.

FIG. 3B is an enlarged cross-sectional view of the power tool of FIG. 2 with the reaction arm decoupled from the power tool.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

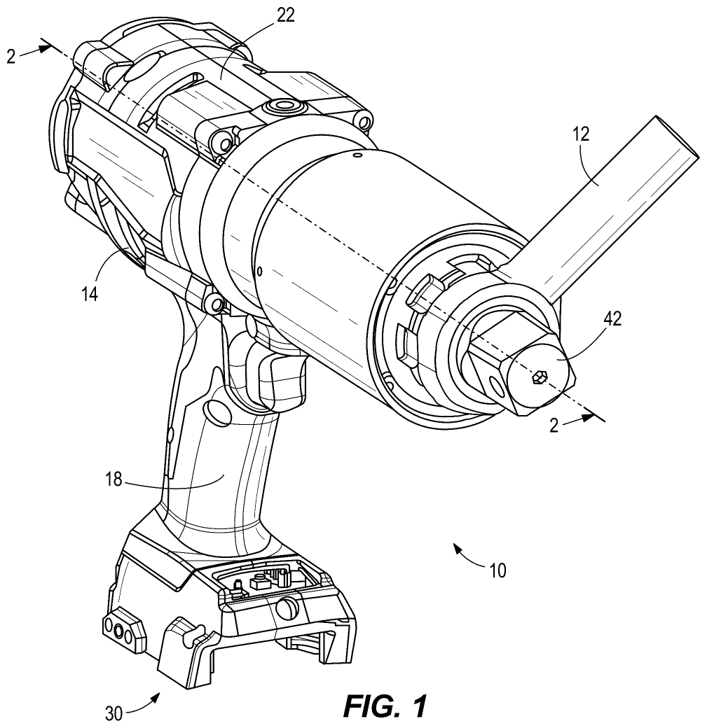

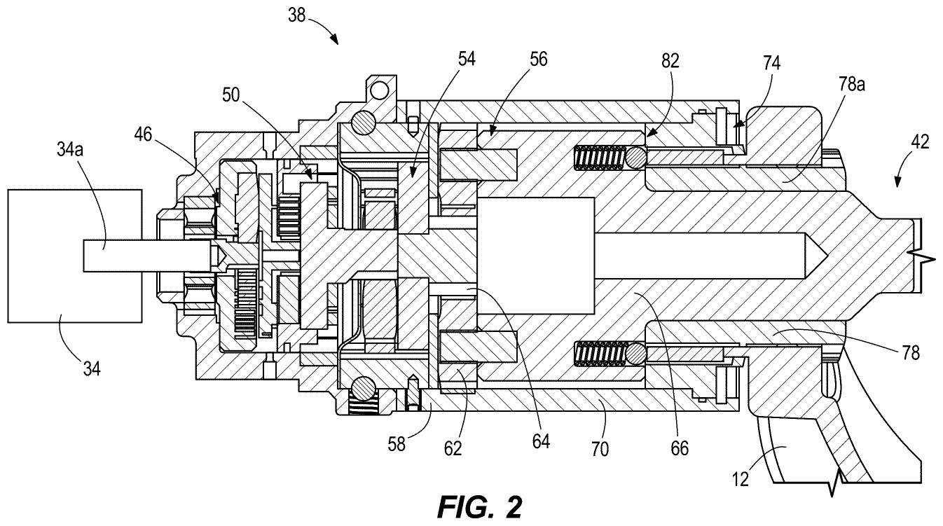

FIGS. 1 and 2 illustrate a power tool 10 in the form of a reaction arm tool-a rotary direct drive power tool configured to apply torque to a workpiece (e.g., a fastener) and having a reaction arm 12 that may brace the tool against a fixed structure (e.g., an adjacent fastener, a wall, a clamp, etc.) to bear the reaction torque. As such, a user operating the power tool 10 does not experience the reaction torque on their hands and wrists allowing for higher torque outputs, repeatability, and reduced user fatigue.

The power tool 10 may be substantially similar to the power tool disclosed in International Publication No. PCT/US2023/027833, in the name of Milwaukee Electric Tool Corporation, the entire contents of which are incorporated herein by reference. As such, with continued reference to FIGS. 1 and 2, the illustrated power tool 10 includes a housing 14 having a handle portion 18, a motor housing portion 22, and a battery receptacle 30 configured to receive a battery pack. In the illustrated embodiment, the battery receptacle 30 is located at a bottom end or foot of the handle portion 18 opposite the motor housing portion 22. A motor 34 is supported within the motor housing portion 22 and operably coupled to a drive assembly 38 (FIG. 2). The motor 34 drives the drive assembly 38 to provide an output torque at an output end or drive 42 of the power tool 10.

With reference to FIG. 2, the drive assembly 38 includes a multi-stage planetary transmission with a plurality of planetary gear stages 46, 50, 54, 56, a last stage ring gear 58, a plurality of last stage planet gears 62, an anvil or output shaft 66, and a clutch mechanism 74. In the illustrated embodiment, the plurality of planetary gear stages 46, 50, 54, 56 includes a first planetary gear stage 46, a second planetary gear stage 50, a third planetary gear stage 54, and a fourth (i.e., the last) planetary gear stage 56. Each of the gear stages 46, 50, 54, 56 includes a ring gear, a plurality of planet gears meshed with the ring gear, and a planet carrier supporting the planet gears; however, only the last stage ring gear 58 and planet gears 62 are described in detail herein.

The first planetary gear stage 46 is positioned in engagement with a pinion fixed to a motor shaft 34a of the motor 34, such that the motor 34 is configured to provide a torque input to the first planetary gear stage 46. The second planetary gear stage 50 is driven by the first planetary gear stage 46 (e.g., via a sun gear on the carrier of the first planetary gear stage 46), and the third planetary gear stage 54 is driven by the second planetary gear stage 50 (e.g., via a sun gear on the carrier of the second planetary gear stage 50). Likewise, the fourth planetary gear stage 56 is driven by the third planetary gear stage 54 (e.g., via a sun gear 64 on the carrier of the third planetary gear stage 54).

With continued reference to FIG. 2, the sun gear 64 is meshed with the last stage planet gears 62, which in turn are meshed with the last stage ring gear 58. The planet gears 62 are supported by pins extending from the output shaft 66, such that the output shaft 66 is the planet carrier of the last planetary gear stage 56. In the illustrated embodiment, the ring gear 58 is an integral portion of an elongated sleeve 70. The output shaft 66 extends through the sleeve 70 and to the output end 42. Specifically, a portion of the output shaft 66 exposed from the sleeve 70 defines the output end 42 of the power tool 10.

The illustrated power tool 10 may be operable in a first or high speed/low torque configuration and a second or low speed/high torque configuration. In the high speed configuration, the power tool 10 may be used without the reaction arm 12. That is, the power tool 10 may be operable in the high speed configuration or mode in response to the reaction arm 12 being decoupled from the tool 10. In this configuration, the sleeve 70 is free to rotate, since the reaction arm 12 is not braced against a workpiece to prevent rotation of the sleeve 70. With the sleeve 70, and thus, the last stage ring gear 58 free to rotate, the speed reduction and torque increase provided by the fourth planetary gear stage 56 is effectively disabled, and the planet gears 62, output shaft 66, and sleeve 70 will all co-rotate with the sun gear 64. The high speed configuration may be advantageous for advancing a fastener a distance along a threaded rod before the fastener engages a workpiece surface, at which point the torque needed to finally tighten the fastener may significantly increase. Once a predetermined torque is reached (e.g., due to resistance to further tightening the fastener), the clutch mechanism 74 slips, permitting the sleeve 70 to rotate relative to the output shaft 66, and thereby permitting the output shaft 66 to remain stationary if the power tool 10 continues to operate. Final tightening of the fastener may then be performed by shifting the power tool 10 to the low speed configuration. In the low speed/high torque configuration, the reaction arm 12 is positioned against a fixed support proximate the workpiece to prevent rotation of the sleeve 70. During operation, the sun gear 64 drives the planet gears 62 to orbit about the inner periphery of the ring gear 58, in turn rotating the output shaft 66 at a higher torque and lower speed than in the high speed configuration. As described in greater detail below, the clutch mechanism 74 may be automatically disabled when the power tool 10 is placed in the low speed configuration (e.g., in response to attaching the reaction arm 12).

The illustrated clutch mechanism 74 includes a clutch collar 78 surrounding the output shaft 66 and a detent lock 82. An inner surface of the clutch collar 78 is sleeved to the output shaft 66 (in a manner permitting relative rotation between the clutch collar 78 and the output shaft 66), and the clutch collar 78 fixed to the sleeve 70 at an outer surface of the clutch collar 78. The clutch collar 78 includes a neck portion 78a that extends forward of the sleeve 70. The neck portion 70a is selectively couplable with the reaction arm 12. Stated another way, the reaction arm 12 is mountable to the neck portion 70a. The neck portion 70a and the reaction arm 12 may include cooperating geometric features, such as splines, to permit the reaction arm 12 to be installed on to and removed from the neck portion 70a (e.g., by sliding the reaction arm 12) but to prevent relative rotation between the reaction arm 12 and the neck portion 70a.

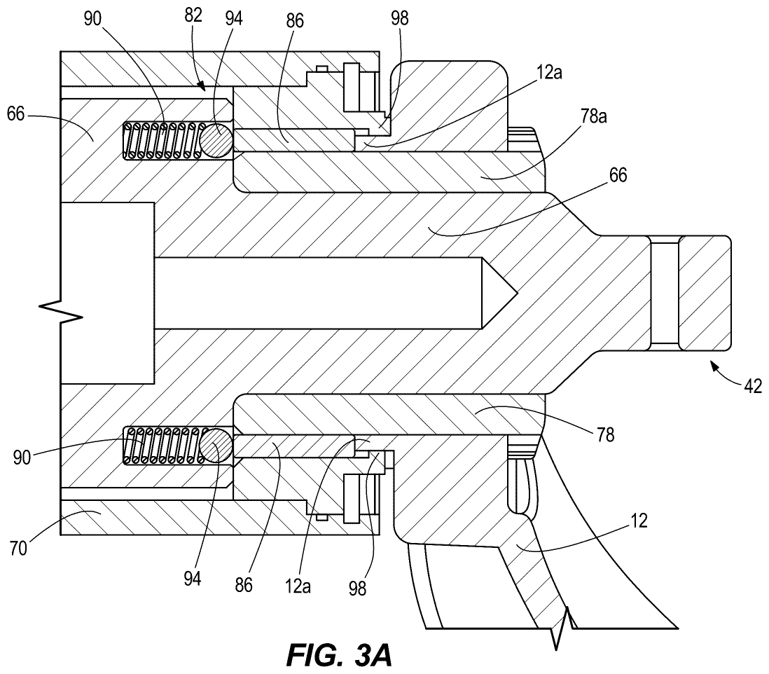

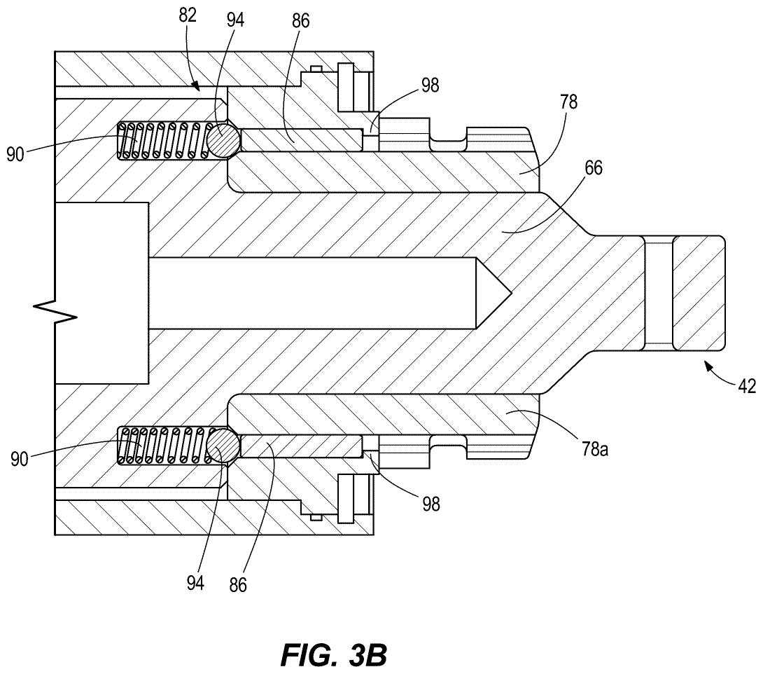

With reference to FIGS. 3A and 3B, the illustrated detent lock 82 includes a pin 86, a spring 90, and a ball detent 94. In some embodiments, the detent lock 82 includes two pins 86, two springs 90, and two ball detents 94. In some embodiments, the detent lock 82 may include more than two pins 86, springs 90, and ball detents 94. For the sake of brevity, the detent lock 82 is only described with respect to one pin 86, one spring 90, and one ball detent 94. As illustrated in FIGS. 3A and 3B, the pin 86 is disposed in a cavity formed in the clutch collar 78. The cavity formed in the clutch collar 78 faces or opens rearwardly (e.g., a direction extending opposite from the output end 42 of the power tool 10). The spring 90 is disposed in a cavity formed in the output shaft 66. The cavity formed in the output shaft 66 faces or opens forwardly (e.g., a direction extending toward the output end 42 of the power tool 10). The ball detent 94 is positioned between the pin 86 and the spring 90 and is movable with and against the bias of the spring 90.

The clutch mechanism 74 has an enabled configuration (FIG. 3B) and a disabled configuration (FIG. 3A) depending on whether the reaction arm 12 coupled to the neck portion 70a of the clutch collar 78. As illustrated in FIG. 3A, when the reaction arm 12 is coupled to the clutch collar 78, the ball detent 94 is pushed against the bias of the spring 90 such that the ball detent 94 is positioned completely within the cavity of the output shaft 66. Specifically, the reaction arm 12 includes protrusions 12a that extend rearwardly into the cavity formed in the clutch collar 78 to push the pin 86, and therefore the ball detent 94, against the bias of the spring 90. As such, when the reaction arm 12 is mounted to the clutch collar 78 such that the ball detent 94 is positioned completely within the cavity formed in the output shaft 66, the output shaft 66 and the clutch collar 78 are rotationally disengaged. In other words, the output shaft 66 and the clutch collar 78 are not configured for co-rotation when the reaction arm 12 is mounted to the clutch collar 78.

As illustrated in FIG. 3B, when the reaction arm 12 is removed from the clutch collar 78, the spring 90 biases the pin 86 and the ball detent 94 forwardly. Specifically, the bias of the spring 90 pushes the ball detent 94 against the pin 86 which pushes the pin 86 into engagement with a flange 98 of the clutch collar 78. The flange 98 of the clutch collar 78 inhibits the pin 86 from sliding out of the cavity formed in the clutch collar 78. With the pin 86 pushed against the flange 98 of the clutch collar 78, the ball detent 94 is positioned between the output shaft 66 and the clutch collar 78 (and received, for example, in one of a plurality of hemispherical recesses formed in a rear side of the clutch collar 78), thereby rotationally coupling the output shaft 66 and the clutch collar 78 together, up to a predetermined torque threshold of the clutch mechanism 74. In other words, the output shaft 66 and the clutch collar 78 are configured for co-rotation when the reaction arm 12 is removed from the clutch collar 78 until the torque threshold is reached or exceeded, at which point the torque between the clutch collar 78 and the output shaft 66 causes the ball detent 94 to retract against the bias of the spring 90. When the ball detent 94 retracts a sufficient distance into its cavity in the output shaft 66, the clutch collar 78 may slip and rotate relative to the output shaft 66.

With reference to FIGS. 2-3B, the power tool 10 may be operated to deliver torque to a workpiece 5. A user may begin operation of the power tool 10 with the reaction arm 12 removed from the power tool 10 (e.g., as illustrated in FIG. 3B). When the reaction arm 12 is removed from the power tool 10, the power tool 10 is configured to provide a high speed, low torque output at the output end 42. With the reaction arm 12 removed, the clutch mechanism 74 is engaged such that the ball detent 94 rotationally couples the output shaft 66 with the clutch collar 78, and torque is transmitted through the drive assembly 38 along a first transmission path in which the sleeve 70 transmits torque to the clutch collar 78, which then transmits torque to the output shaft 66 via the ball detent 94. In the first transmission path, torque transmission effectively skips the last planetary gear stage 56 to provide the high speed, low torque output.

While operating the power tool 10 without the reaction arm 12 such that torque is transmitted through the first transmission path, resistance provided by the workpiece 5 may eventually reach the threshold torque of the clutch mechanism 74. At the threshold torque, the clutch mechanism 74 slips, as described above, and the output shaft 66 may stop rotating. The user may then mount, or attach, the reaction arm 12 to the clutch collar 78. When the reaction arm 12 is attached to the power tool 10, the power tool 10 is configured to provide a low speed, high torque output at the output end 42. Specifically, with the reaction arm 12 attached, the ball detent 94 is moved to rotationally decouples the output shaft 66 and the clutch collar 78. The reaction arm 12 engages the workpiece to prevent rotation of the sleeve 70, and torque is transmitted along a second transmission path through all of the planetary gear stages 46, 50, 54, 56 to provide the low speed, high torque output.

Although the disclosure has been described in detail with reference to certain preferred embodiments, variations and modifications exist within the scope and spirit of one or more independent aspects of the disclosure as described.

Various features and aspects of the present disclosure are set forth in the following claims.

What is claimed is:

1. A power tool comprising:
a housing;
a motor supported within the housing;
a drive assembly disposed within the housing and configured to be driven by the motor, the drive assembly including an output shaft and clutch mechanism with a collar surrounding the output shaft, the drive assembly operable in a first configuration, in which the collar is coupled for co-rotation with the output shaft, and a second configuration, in which the collar is rotatable relative to the output shaft; and
a reaction arm configured to be removably coupled to the collar.

2. The power tool of claim 1, wherein the drive assembly is operable in the first configuration only when the reaction arm is decoupled from the collar.

3. The power tool of claim 1, wherein the clutch mechanism includes a spring and a detent supported by the output shaft, the spring biasing the detent toward the collar.

4. The power tool of claim 3, further comprising a pin extending through the collar, wherein the pin engages the detent to displace the detent away from the collar against the bias of the spring when the reaction arm is coupled to the collar.

5. The power tool of claim 4, wherein the reaction arm includes a protrusion engageable with the pin to displace the pin and the detent against the bias of the spring.

6. The power tool of claim 3, wherein the detent engages the collar to couple the collar for co-rotation with the output shaft in the first configuration up to a threshold torque on the output shaft.

7. The power tool of claim 6, wherein the detent is movable away from the collar against the bias of the spring to allow the collar to rotate relative to the output shaft in response to a torque on the output shaft exceeding the threshold torque.

8. The power tool of claim 1, wherein the drive assembly includes a ring gear and a plurality of planet gears meshed with the ring gear, the plurality of planet gears carried by the output shaft.

9. The power tool of claim 8, wherein the collar is fixed to the ring gear.

10. The power tool of claim 9, wherein the collar and the reaction arm include cooperating splines.

11. The power tool of claim 1, wherein the drive assembly includes a multi-stage planetary transmission having a plurality of gear stages, wherein each of the plurality of gear stages provides a speed reduction and torque increase when the drive assembly is in the second configuration and the reaction arm is coupled to the collar and engaged with a fixed support, and wherein at least one of the plurality of gear stages is disabled, such that the output shaft is rotatable at a relatively higher speed and lower torque, when the drive assembly is in the first configuration.

12. A power tool comprising:
a housing;
a motor supported within the housing;
a drive assembly disposed within the housing, the drive assembly including a sun gear driven by the motor, a ring gear, a plurality of planet gears meshed with the sun gear and the ring gear, an output shaft carrying the plurality of planet gears, and a collar surrounding the output shaft; and
a reaction arm configured to be removably coupled to the collar,
wherein the collar is fixed to the ring gear,
wherein the output shaft is rotatable relative to the ring gear when the reaction arm is coupled to the collar and engaged with a fixed support, and
wherein the ring gear and the output shaft are configured to co-rotate when the reaction arm is decoupled from the collar and a torque on the output shaft is less than a threshold torque.

13. The power tool of claim 12, wherein the ring gear is rotatable relative to the output shaft when the reaction arm is decoupled from the collar and a torque on the output shaft is greater than the threshold torque.

14. The power tool of claim 12, wherein the drive assembly includes a clutch mechanism comprising the collar, a detent, and a spring, wherein the detent and the spring are supported by the output shaft, and wherein the detent is biased into engagement with the collar by the spring when the reaction arm is decoupled from the collar.

15. The power tool of claim 14, wherein coupling the reaction arm to the collar moves the detent away from the collar against the bias of the spring.

16. The power tool of claim 15, further comprising a pin extending through the collar, wherein the reaction arm includes a protrusion engageable with the pin to move the detent away from the collar.

17. The power tool of claim 12, wherein the drive assembly includes a multi-stage planetary transmission comprising a plurality of gear stages, and wherein the ring gear and the plurality of planet gears define a last stage of the plurality of gear stages.

18. A power tool comprising:
a housing;
a motor supported within the housing;
a drive assembly disposed within the housing and configured to be driven by the motor, the drive assembly including an output shaft and a collar surrounding the output shaft; and
a reaction arm configured to be removably coupled to the collar,
wherein the drive assembly is operable in a high speed low torque mode in response to the reaction arm being decoupled from the collar, and wherein the drive assembly is operable in a low speed high torque mode in response to the reaction arm being coupled to the collar.

19. The power tool of claim 18, wherein the drive assembly includes a ring gear fixed to the collar and a plurality of planet gears meshed with the ring gear and carried by the output shaft.

20. The power tool of claim 19, wherein the ring gear is rotatable relative to the housing in the high speed low torque mode.
